(19) United States
(12) Patent Application Publication
(10) Pub. No.: US 2006/0107840 A1
(43) Pub. Date: May 25, 2006

(54) Method and device for forming a foam-head on a beverage

(75) Inventor: Edgar Ivo Maria Van Der Heijden, Broek op Langedijk (NL)

Correspondence Address: HOFFMANN & BARON, LLP, 6900 JERICHO TURNPIKE, SYOSSET, NY, 11791, US

(73) Assignee: Airspray N.V., Alkmaar (NL)

(21) Appl. No.: 10/531,762

(22) PCT Filed: Oct. 20, 2003
(86) PCT No.: PCT/NL03/00707

§ 371 Date: Sep. 29, 2005

(30) Foreign Application Priority Data
Oct. 18, 2002 (NL) 1021699

(51) Int. Cl. A47J 31/44

(52) U.S. Cl. 99/279

(57) ABSTRACT

A method for preparing a beverage which is suitable for human consumption, comprising the steps of: filling a glass or the like with a base liquid which is suitable for human consumption, and using a foam-dispensing foam-dispensing device has a foam liquid which is suitable assembly having an air pump device to form a foam, which reservoir containing a stock of for human consumption and a pump and a liquid pump, as well as from a dispensing opening of glass which has been filled foam-forming means for forming foam using the pumped air and foam liquid, and supplying the foam dispensed the foam-dispensing device to the with base liquid, so that the foam forms a head on top of the base liquid.

The present invention relates to the preparation of a beverage which is suitable for human consumption in a glass, cup or the like, in which there is a head on the beverage.

It is known from U.S. Pat. No. 2,977,231 to prepare a beverage with the aid of an aerosol can which is filled with a syrup solution. In this case, the syrup solution is sprayed as a high-velocity jet into a glass filled with a base liquid, for example water or milk. As a result, the base liquid acquires the colour and flavour of the syrup. In this method, some bubbles are formed, so that a thin layer of foam is formed on the surface of the base liquid.

The known method is not suitable for forming a beverage with a real head.

Another drawback of the known method is the use of an aerosol can. Aerosol cans are expensive and are not environmentally friendly.

Another drawback of the known method is that the aerosol can cannot readily be given to children to allow them to prepare their own beverage, since there is a high risk of them making a mess.

It is an object of the invention to propose alternatives which allow a beverage with a head to be prepared.

In particular, it is an object of the invention to propose alternatives which allow children to prepare a (non-alcoholic) beverage with a head themselves.

It is a further object of the invention to provide foam-dispensing devices which make it easy for the user, in particular a child, to produce a beverage with a head.

A first aspect of the invention relates to a method for preparing a beverage which is suitable for human consumption, comprising the steps of:

filling a glass or the like with a base liquid which is suitable for human consumption, and

using a foam-dispensing device to form a foam, which foam-dispensing device has at least one reservoir containing a stock of foam liquid which is suitable for human consumption and a pump assembly having an air pump and a liquid pump, as well as foam-forming means for forming foam using the pumped air and foam liquid, and

supplying the foam dispensed from a dispensing opening of the foam-dispensing device to the glass which has been filled with base liquid, so that the foam forms a head on top of the base liquid.

It should be noted that in the present context the term foam liquid means that this liquid is formed into a foam with air. In practice, the foam liquid will contain one or more ingredients which promote the formation of a foam.

Unlike in the prior art, the method according to claim 1 does not use an aerosol can, but rather uses a foam-dispensing device with an air pump, liquid pump and foam-forming means. Foam-dispensing devices of this type are already marketed, for example by the Applicants, in a design which is easy to handle and can be actuated using a push-button.

The pump assembly of the foam-dispensing devices can preferably be releasably coupled to the reservoir, so that the reservoir can be refilled or an empty reservoir can be replaced.

In particular, foam-dispensing devices of this type are easy for children to actuate.

The flow of foam coming out of the foam-dispensing device is at a relatively low velocity, certainly compared to the jet which emerges from an aerosol can, which safely allows children to prepare their own beverages. Furthermore, only one portion of foam is dispensed each time the pump assembly is actuated, making metering easier than with an aerosol can, certainly for children.

In an advantageous embodiment of the method, the dispensing opening is held below the level of the base liquid, so that the foam rises in the base liquid and forms the head on top of the latter.

The foam liquid preferably contains colourings and/or flavourings. If the dispensing of foam in this case takes place below the level of the base liquid, the base liquid will (partially) acquire the colour and/or flavour of the foam rising in the base liquid. Surprisingly, it has been found that the rising foam leads to excellent mixing of colourings and flavourings with the base liquid, so that there is no need to stir the base liquid—which could have an adverse effect on the head.

The foam liquid preferably contains an excess of colourings and/or flavourings compared to the quantity which is required to impart colour and/or flavour to the foam which is formed. The excess of these/this substance(s) promotes the formation of colour and/or flavour in the base liquid.

In an advantageous embodiment, the foam liquid contains a syrup, for example a fruit syrup. A syrup of this type can easily be used to prepare a beverage with a head which is suitable for children.

The invention also relates to the use of a, preferably hand-held, foam-dispensing device comprising a reservoir for a liquid and a pump assembly having an air pump and a liquid pump, as well as foam-forming means for forming foam using the pumped air and liquid, for the purpose of preparing a beverage which is suitable for human consumption in a glass or the like, the beverage having a head.

The invention also relates to foam-dispensing devices which are particularly suitable for carrying out the method according to the invention.

The invention will be explained in more detail below with reference to the drawing, in which:

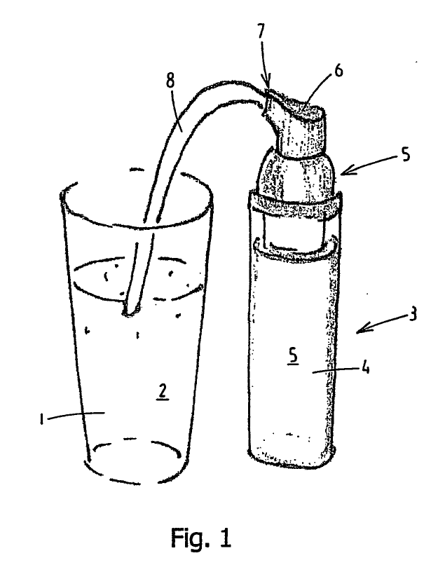

FIG. 1 shows the preparation of a (children's) beverage in accordance with a first embodiment of the invention,

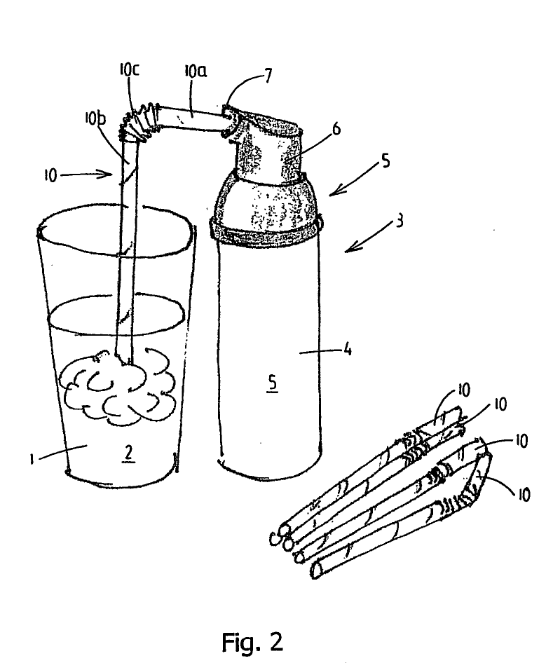

FIG. 2 shows the preparation of a (children's) beverage in accordance with a second embodiment of the invention,

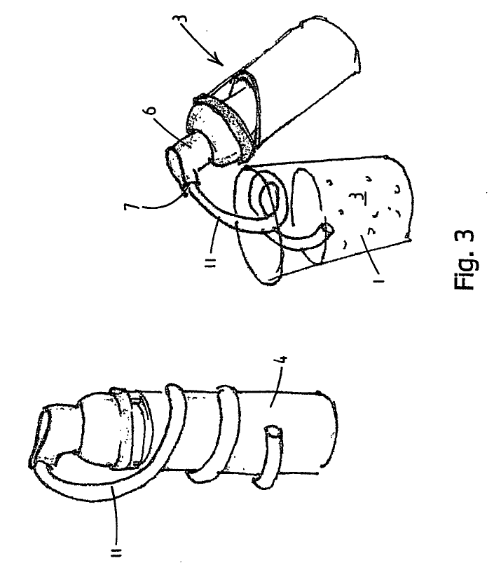

FIG. 3 shows the preparation of a (children's) beverage in accordance with a third embodiment of the invention,

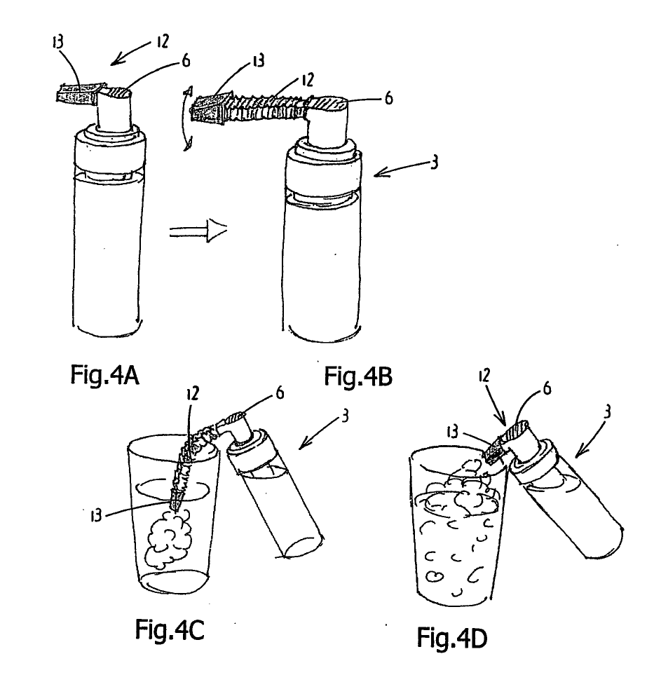

FIGS. 4a-d show the preparation of a (children's) beverage in accordance with a fourth embodiment of the invention, and

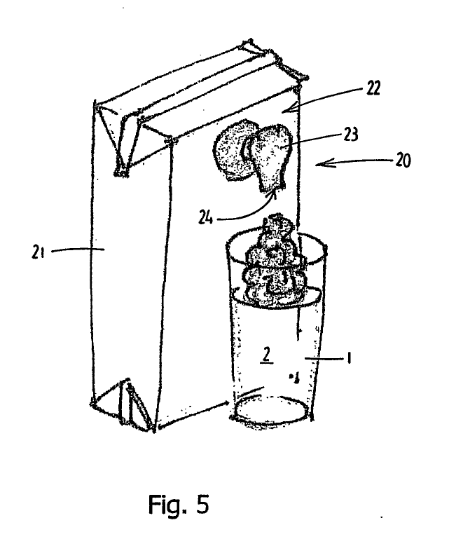

FIG. 5 shows the preparation of a (children's) beverage in accordance with a fifth embodiment of the invention.

FIG. 1 shows a glass 1 which has been filled with a base liquid 2, in this example water. A user, for example a child, can use a foam-dispensing device 3, which is to be explained in more detail below, to convert the water 2 into lemonade and also to form a head on top of the lemonade.

The foam-dispensing device 3 is of the hand-held type and has a reservoir 4 which holds a stock of foam liquid which is suitable for human consumption. In this example, the foam liquid contains colourings and/or flavourings in amounts such that a proportion of these colourings and/or flavourings can change the colour and/or flavour of the base liquid. By way of example, the foam liquid contains (fruit) syrup.

The device 3 has a pump assembly 5 with an air pump and a liquid pump, as well as foam-forming means for forming a foam using the pumped air and foam liquid. A pump assembly 5 of this type is generally known and can in an advantageous embodiment be secured as an integral unit to a neck of the reservoir 4, for example releasably. In the latter embodiment, the reservoir 4 can be topped up or exchanged.

The device 3 has a push-button 6 which can be moved up and down and simultaneously actuates the air pump and the liquid pump. In the process, the air pump sucks in ambient air and the liquid pump extracts foam liquid from the reservoir 4. A foam-dispensing passage with an outlet opening 7 is located in the push-button 6.

In this case, a flexible dispensing line 8 is connected, preferably releasably, to the outlet opening 7.

To convert the water 2 in the glass 1 into lemonade and at the same time to form a head, the user introduces the dispensing line 8 into the water 2 and actuates the push-button 6. In this way, foam is formed and enters the glass 1 below the level of the water 2. The foam rises upwards and in doing so changes the colour and/or flavour of the water 2, so that the water 2 becomes lemonade. Furthermore, the foam forms a head on the water, the head being of the same colour and flavour as the lemonade. In order in practice to enable the dispensing opening of the dispensing line 8 to project into the base liquid, it is preferable for the length of the, preferably flexible, dispensing line 8 to be at least 5 centimetres.

The embodiment shown in FIG. 2 largely corresponds to that shown in FIG. 1, and therefore corresponding parts are denoted by the same reference numerals.

What is different is the design of the dispensing line, which in FIG. 2 is designed as a drinking straw 10, so that after the beverage has been prepared the dispensing line 10 can be detached and can be used as a drinking straw 10. The straw 10 comprises two rigid line parts 10a, 10b which are connected by a flexible part 10c.

As a result, the user can remove the straw 10 after the beverage has been prepared and can use it to consume the beverage. By way of example, there is provision for the dispensing device 3 (or the associated reservoir) and a plurality of drinking straws 10 to be supplied to the consumer in a pack.

FIG. 3 once again shows the foam-dispensing device 3, now provided with a flexible dispensing line 11 which can be wound around the reservoir 4 in one or more loops, for example helically.

FIGS. 4a-d once again show the foam-dispensing device 3, and in this case a dispensing line 12 with a concertina construction is provided, so that the dispensing line 12 is flexible and the length of the dispensing line 12 can be varied. The line 12 has a dispensing nozzle 13 which can be coupled to the push-button in the retracted state of the line 12.

As shown in FIGS. 4c and 4d, this device 3 with a concertina line 12 can be used to dispense the foam into the base liquid (FIG. 4c) or to dispense the foam onto the top of the base liquid (FIG. 4d).

To promote the dispersion of the foam, it is possible for the dispensing nozzle to include a plurality of dispensing openings. FIG. 5 shows a foam-dispensing device 20 with a reservoir 21 in carton form for foam liquid, for example having a wall comprising cardboard, as is known for beverages, and having a pump assembly 22. A dispensing mouth 24 which is integral with the push-button 23 of the pump assembly 22 for dispensing the foam is directed downwards on one side of the reservoir 21, in such a manner that the glass 1 can be placed next to the reservoir 21 and the foam can flow into the glass from above.

In an embodiment which is not shown, the foam-dispensing device has a reservoir of variable volume which decreases when foam liquid is extracted from the reservoir. By way of example, the reservoir is a pouch or a reservoir with a moveable plunger.

The foam liquid may take a wide variety of forms, provided that it is suitable for human consumption. By way of example, the foam liquid contains a surfactant and/or a foam-stabilizing ingredient.

In another embodiment which is not shown, the foam-dispensing device is designed with a plurality of reservoirs which hold different foam liquids which can be dispensed separately or simultaneously, depending on the design of the device.

1. Method for preparing a beverage which is suitable for human consumption, comprising the steps of:
filling a glass or the like with a base liquid which is suitable for human consumption, and
using a foam-dispensing device to form a foam, which foam-dispensing device has a reservoir containing a stock of foam liquid which is suitable for human consumption and a pump assembly having an air pump and a liquid pump, as well as foam-forming means for forming foam using the pumped air and foam liquid, and
supplying the foam dispensed from a dispensing opening of the foam-dispensing device to the glass which has been filled with base liquid, so that the foam forms a head on top of the base liquid.

2. Method according to claim 1, in which the foam-dispensing device is held with its dispensing opening below the level of the base liquid, so that the foam rises in the base liquid and forms a head on top of the latter.

3. Method according to claim 1, in which the foam liquid contains colourings and/or flavourings in an amount which is such that a proportion of the colourings and/or flavourings change the colour and/or flavour of the base liquid.

4. Method according to claim.3, in which the foam liquid contains syrup, for example fruit syrup.

5. Method according to claim 2, in which the foam-dispensing device is provided with a, preferably flexible, dispensing line which at one end is connected to the pump assembly and at the other end forms the dispensing opening for the foam, so that the user can hold the dispensing opening below the level of the base liquid.

6. Method according to claim 5, in which the dispensing line is of removable design.

7. Method according to claim 6, in which the dispensing line is designed as a drinking straw, so that after the beverage has been prepared, the dispensing line can be detached and used as a drinking straw.

8. Method according to claim 5, in which the flexible dispensing line comprises two rigid line parts which are connected by a flexible part.

9. Method according to claim 5, in which the dispensing line has a concertina-like construction, so that the dispensing line is flexible and the length of the dispensing line can be varied.

10. Method according to claim 5, in which a dispensing nozzle is located at the free end of the dispensing line.

11. Method according to claim 10, in which the dispensing nozzle has a plurality of dispensing openings for the foam.

12. Method according to claim 1, in which the pump assembly comprises a common manual actuation member, preferably a push-button, for manual actuation of the air pump and the liquid pump.

13. Method according to claim 1, in which a dispensing mouth formed on the pump assembly is directed downwards on one side of the reservoir, in such a manner that the glass can be placed next to the reservoir and the foam can flow into the glass from above.

14. Method according to claim 1, in which the reservoir is a cardboard container, for example in carton form.

15. Use of a foam-dispensing device comprising a reservoir for a foam liquid which is suitable for human consumption and a pump assembly having an air pump and a liquid pump, as well as foam-forming means for forming foam using the pumped air and foam liquid, for preparing a beverage which is suitable for human consumption in a glass or the like, the beverage having a head.

16. Foam-dispensing device comprising a reservoir for a foam liquid and a pump assembly having an air pump and a liquid pump, as well as foam-forming means for forming a foam using the pumped air and foam liquid, the reservoir being filled with a foam liquid which is suitable for human consumption, in such a manner that, as a result of foam being dispensed into a glass filled with a base liquid, a head is formed, the dispensing opening for the foam preferably being located below the level of the base liquid which has previously been introduced into the glass, so that foam rises and the base liquid gains flavour and colour from the foam, and the head is formed.

17. Foam-dispensing device according to claim 16, in which a, preferably flexible, dispensing line is provided, which at one end is or can be connected to the pump assembly and at the other end forms the dispensing opening for the foam, so that the user can hold the dispensing opening below the level of the base liquid.

18. Foam-dispensing device according to claim 17, in which the length of the dispensing line is at least 5 centimetres.

19. Foam-dispensing device according to claim 17, in which the dispensing line is designed as a drinking straw, so that after the beverage has been prepared the dispensing line can be detached and used as a drinking straw.

20. Foam-dispensing device according to claim 17, in which the dispensing line comprises two rigid line parts which are connected by a flexible part.

21. Foam-dispensing device according to claim 17, in which the dispensing line has a concertina construction, so that the dispensing line is flexible and the length of the dispensing line can be varied.

22. Foam-dispensing device according to claim 17, in which a dispensing nozzle is located at the free end of the dispensing line.

23. Foam-dispensing device according to claim 22, in which the dispensing nozzle forms a plurality of dispensing openings for the foam.

24. Foam-dispensing device according to claim 16, in which the pump assembly comprises a common manual actuation member, preferably a push-button, for manual actuation of the air pump and the liquid pump.

25. Foam-dispensing device according to claim 17, provided with a flexible dispensing line which can be wound around the reservoir in one or more loops, preferably over a helical path.

26. Foam-dispensing device according to claim 17, in which the foam liquid contains a surfactant.

27. Foam-dispensing device according to claim 16, in which the foam liquid contains a foam-stabilizing ingredient.

28. Pack comprising a foam-dispensing device which is filled with a foam liquid which is suitable for human consumption and has a plurality of, preferably more than five, dispensing lines which are suitable for use as drinking straws.
